(19) United States
(12) Patent Application Publication
(10) Pub. No.: US 2004/0240414 A1
(43) Pub. Date: Dec. 2, 2004

(54) Method for carrying out a qos-oriented handoff between a first and a second ip-based especially mobile ipv6-based communication path between a mobile node (mn) and a correspondent node (cn)

(76) Inventors: Changpeng Fan, Berlin (DE); Andreas Festag, Berlin (DE); Xiaoming Fu, Berlin (DE); Cornelia Kappler, Berlin (DE); Holger Karl, Berlin (DE); Mirko Schramm, Berlin (DE); Gunter Schafer, Berlin (DE)

Correspondence Address: MORRISON & FOERSTER LLP, 1650 TYSONS BOULEVARD, SUITE 300, MCLEAN, VA, 22102, US

(21) Appl. No.: 10/483,223

(22) PCT Filed: Jul. 10, 2001
(86) PCT No.: PCT/DE01/02547

(51) Int. Cl. H04L 12/56; H04Q 7/00

(52) U.S. Cl. 370/332; 370/400

(57) ABSTRACT

The invention relates to a method for carrying out a QoS-oriented handoff between a first and a second IP-based, especially mobile IPv6-based, communication path, between a mobile node (MN) and a correspondent node (CN), the second communication path being part of a number of communication paths which can be accessed by the mobile node, with no, one, or a plurality of intermediate instances. The inventive method comprises at least the following steps: (a) a communication path is selected from the communication paths which can be accessed by the mobile node, as a second communication path; (b) a message (BU) is generated by the mobile node, said message containing at least one IP address which is associated with the mobile node on the basis of the selected communication path, and containing minimum quality of service requirements (QoS) in terms of the selected communication path; (c) the ability to meet at least the minimum quality of service requirements is controlled and optionally ensured by the individual intermediate instances through which the message passes successively, on the selected communication path and/or through the correspondent node. The message contains the minimum quality of service requirements for a communication from the mobile node to the correspondent node and/or vice versa. A handoff is automatically carried out between the first communication path and the second selected communication path, when at least the minimum quality of service-requirements are met or the message is stopped. A notice is generated in an intermediate instance and/or in the correspondent node and is sent to the mobile node if the ability to meet the minimum quality of service requirements is, not ensured.

The invention relates to a method for carrying out a QoS-oriented handoff between a first and a second IP-based, especially mobile IPv6-based communication path between a mobile node (MN) and a correspondent node (CN). As the most varied access technologies to IPv6-based networks are developed, these networks will be forced more and more to guarantee a particular quality of service (QoS) also in mobile network systems. Mobile IPv6 ensures correct routing of data packets to a mobile node (MN) if the mobile node changes its point of attachment to the IPv6-based network. This is explained, for example, in “D. Johnson and C.

Perkins, Mobility Support in IPv6, Internet Draft, draft-ietf-mobileip-ipv6-13.txt, work-in-progress, November 2000”. Furthermore, however, it is also necessary to provide for an adequate quality of service (QoS) during a change of the point of attachment by the mobile node, in accordance with the data packets to be transported, so that QoS-sensitive IP services can also be supported by means of mobile IPv6.

In a document by H. Chaskar and R. Koodli “Framework for QoS Support in Mobile IPv6”, Internet Draft, draft-chaskar-mobileeip-qos-01, work-in-progress, March 2001, an IPv6-based option called “QoS object option” is already introduced. This QoS object contains information on the quality of service requirements to be met by the communication path between the mobile node and a corresponding correspondent node in order to guarantee a satisfactory service. Such a QoS object is included as so-called “hop-by-hop” option in IPv6 data packets which can additionally contain so-called binding update (BU) or binding acknowledgment (BA) header options (so-called binding update message or binding acknowledgment message, respectively). A binding update message is sent, for example, from a mobile node to a corresponding network node, for example to a correspondent node in order to inform the latter about a new IP address of the mobile node if the former has changed its site and thus, possibly, its IP address. A binding acknowledgment message (BA message) is virtually the answer to the binding update message (BU message) and in most cases contains the information that the new IP address has been recognized by the correspondent node. This recognition of a new IP address and subsequent utilization of this new address, the general effect of which is the routing of packets along another route or another path, respectively, is called handoff within the context of the present invention. In conventional mobile IPv6, a binding update message passes along the entire path from the mobile node to the corresponding correspondent node. In general, however, this is not sensible because the predominant majority of the handoffs are local, i.e. the mobile node only changes from one base station to an adjacent one. The consequence of locality is that the old and new route of the old and new path, respectively, i.e. before and after the handoff, differ only slightly and diverge only in the vicinity of the mobile node.

This consideration forms the basis for the concept of “hierarchical registration”. According to this, the BU message is not in each case sent to the correspondent node (CN) but intermediate entities, so-called mobility anchor points (MAP) are set up in the network which are also capable of performing a handoff. The data then flow from the CN over the MAP to the MN and conversely. A BU message then only needs be sent to the MAP and no longer to the CN itself, if the MAP is capable of serving both the old IP address and the new IP address. If it cannot do this, the BU message must be forwarded in the direction of the CN and a new MAP must be determined. To reduce the frequency of such a communication with a possibly far distant MAP, further hierarchies of MAPs can be introduced which are in each case based on the same basic principle, i.e. the data are then routed successively from the mobile node via successive MAPs in the hierarchy to the CN and correspondingly in the reverse direction. This is called a hierarchical registration since signaling messages in such a hierarchy need to be forwarded by MAPs only until a MAP has been found which covers both old and new IP addresses of the MN. In the boundary case, the CN must also be contacted in this case.

Chaskar's concept of the QoS object provides an elegant way of dealing with quality of service requirements particularly in the case of hierarchical registration. In such a case, a binding update message only passes to the network node where the old and the new communication paths deviate from one another. It is only up to this network node that changes with respect to the quality of service, i.e. the available QoS can occur compared with the old communication path. Since most of the so-called handoffs, i.e. most of the site changes of a mobile node connected with a change of its IP address are local, this is the most efficient procedure. If necessary the corresponding binding acknowledgment message then also comes from this network node. If then a QoS object, introduced by Chaskar, is included in these messages as so-called hop-by-hop options, this means that the corresponding binding update message, when passing a number of network nodes along the way from the mobile node through the network system to the network node at which the old communication path and the new communication path converge, triggers the provision of required resources in the individual network nodes having QoS or responsible for the provision of the corresponding QoS resources. In particular, however, Chaskar does not specify what has to happen in the case of inadequate resources.

It was then an object of the present invention to provide a method with the aid of which it is made possible to recognize as quickly as possible whether the selected communication path to a correspondent node meets the quality-of-service requirements or if an alternative communication path to the corresponding correspondent node must be found. A handoff between an old communication path and a new communication path should only take place if the quality-of-service requirements can be met and reserved along the new communication path, expressly including the possibility of a best-effort quality requirement.

This object is achieved by a method as claimed in claim 1.

Advantageous embodiments of the method according to the invention are given in the corresponding subclaims.

According to claim 1, a method for carrying out a QoS-oriented handoff between a first and a second IP-based, especially mobile IPv6-based communication path between a mobile node (MN) and a correspondent mode (CN) is provided, the second communication path belonging to a number of communication paths accessible to the mobile node, with no, one or a number of intermediate entities and the method exhibiting at least the following steps:

a. selecting a communication path from the number of communication paths accessible to the mobile node as second communication path,

b. generating a message (BU) by the mobile node, which contains at least one IP address allocated to the mobile node on the basis of the selected communication path, and minimum quality-of-service requirements (QoS) with respect to the selected communication path,

c. checking and possibly securing the capability of meeting at least the minimum quality-of-service requirements by the individual intermediate entities successively to be passed by the message on the selected communication path and/or by the correspondent node,

the message containing minimum quality-of-service requirements for a communication from the mobile node to the correspondent node and/or conversely, and a handoff being carried out automatically between the first communication path and the communication path selected as the second one when at least the minimum quality-of-service requirements are met or the message being stopped and a message being generated in an intermediate entity and/or in the correspondent node and sent to the mobile node if the capability of meeting at least the minimum quality-of-service requirements does not exist.

In this method, the message in step b. does not need to be generated in the mobile node but must be generated by it. I.e. the mobile node initiates at least the generation of the message. For example, the mobile node can instruct a base station or its controller to allow the BU to pass successively through the intermediate entities located along the selected communication path. In each case a base station is allocated to both the first communication path and to that selected as the second one. For example the following cases can occur:

It may be desirable to save resources of the air interface, i.e. on the link between mobile node and base station. For this reason, the mobile node sends to the base station of the communication path selected as the second one, a BU without QoS object and instructs it to obtain the minimum quality-of-service requirement from the base station of the first communication path.

In another case, the mobile node does not yet have a connection to the base station of the communication path selected as the second one but only knows its identity. For this reason, it instructs the base station of the first communication path to construct the base station of the communication path selected as the second one to send a corresponding BU.

In contrast to the QoS object option proposed by Chaskar, after the capability to meet the quality-of-service requirements has been checked, either the binding update message (BU) is discarded and a message is generated which informs the mobile node that the quality-of-service requirements cannot be met which will be called negative binding acknowledgment message (BA) in the text which follows, or the binding update message is forwarded when the quality-of-service requirements can be met. Chaskar does not specify what must happen to meet the quality-of-service requirements in the case of inadequate resources. According to the method according to the invention, the mobile node is informed of such a circumstance by means of a negative binding acknowledgment message. Following this, either the minimum quality-of-service requirement is lowered in accordance with the quality of service existing on the selected communication path, and the method according to the invention is reinitialized with the same communication path selected as the second one, or an alternative communication path is selected as the second communication path and the method is then repeated, or the method according to the invention is repeated after a waiting time. It depends on the implementation which one of these possibilities is selected and can depend, for example, on how long the connection to the base station of the first communication path can still be maintained.

In addition, the quality-of-service requirements for the upstream traffic and the downstream traffic between the mobile node and the correspondent node can be sent at the same time as the binding update message. It can thus be ensured or determined as rapidly as possible whether the communication path meets the corresponding quality-of-service requirements both for the communication from the mobile node to the correspondent node (upstream traffic) and for the corresponding communication from the correspondent node to the mobile node (downstream traffic). However, the possibility also exists that the quality-of-service requirements for the downstream traffic are sent with the binding acknowledgment message.

A handoff will only be carried out if all intermediate entities involved along the new communication path, i.e. all units dealing with QoS protection, are capable of providing the required resources for meeting the quality-of-service requirements. Otherwise, the QoS protected old communication path continues to exist and will still be used whilst the mobile node, due to the message or the negative binding acknowledgment message, respectively, is capable of looking for and setting up other communication paths via other base stations.

The message generated in step b. preferably contains a range of quality-of-service requirements which extends from the minimum quality-of-service requirements up to the desired quality-of-service requirements. This means that, apart from the minimum quality-of-service requirements which must be met in order to provide for corresponding communication between the mobile node and the correspondent node at all, also those quality-of-service requirements are listed which would achieve an adequate up to an optimum communication between the mobile node and the correspondent node. As an additional option, the minimum quality-of-service requirement can also be a best-effort service. This is appropriate, especially in the case where an MN, e.g. due to its movement, can only establish contact to a single other base station or expect to lose the connection to the base station of the first communication path soon.

During the check of the existing QoS resources, it is checked first whether the desired quality-of-service requirements which would achieve optimum communication can be met. If this is so, the binding update message is simply forwarded. If the desired quality-of-service requirements cannot be met, a check is made which quality-of-service requirements can just be met. These are then entered in the QoS object and can possibly overwrite the desired quality-of-service requirements. If at least the minimum quality-of-service requirements are met, the message is forwarded and the capability of meeting the minimum quality-of-service requirements or possibly the higher requirements is secured within the range of still available resources by reserving the corresponding resources.

In a preferred embodiment of the method, in the case of a handoff being carried out, a message providing information on what quality-of-service requirements can be met is generated in an intermediate entity and sent to the mobile node at the same time, or after the handoff has been carried out, so that the mobile node is informed about the quality with which the communication between it and the correspondent node is implemented. This means that the mobile node is informed of the finally reserved quality of service by the binding acknowledgment message which, in turn, can contain informative QoS objects, i.e. those not used for checking purposes.

The intermediate entities which check the capability of meeting the quality-of-service requirements are preferably network elements which deal with QoS protection. These can be, for example, mobility anchor points (MAP) but also routers or base stations or their controllers which are arranged along the communication path in question and are passed by the binding update message sent in the direction of the correspondent node. Not all of these intermediate entities are also capable at the same time of generating corresponding messages which are to be sent to the mobile node in order to inform it about what quality-of-service requirements can be met and/or that the minimum quality-of-service requirements cannot be met. The binding update message is preferably forwarded by such an intermediate entity such as, for example, a router which, although it can determine the capability of meeting the quality-of-service requirements, cannot stop the message and generate and send out a corresponding message, with a corresponding note. On the basis of this note, the binding update message is stopped in a next possible intermediate entity located on the selected communication path, which itself does not necessarily deal with QoS protection, in the case that even the minimum quality-of-service requirements cannot be met, and a corresponding message is generated and sent to the mobile node.

The QoS object introduced by Chaskar is a hop-by-hop header option which must be looked at by each node. In the present invention, it is also possible under certain conditions to select instead a so-called destination header option which only needs to be looked at by addressees, for example when all intermediate entities are MAPs since passing packets are in each case addressed to them.

The advantage of the present invention compared with known procedures, such as, for example, RSVP, is the fact that the availability of resources along a new communication path between a mobile node and a correspondent node, in the case where the mobile node changes its site and thus possibly also its IP address, can be checked and possibly protected with minimum overhead since the corresponding quality-of-service requirements are coupled to another message, namely the binding update message (BU) and sent instead of being sent with a separate protocol. Moreover, the availability of the necessary resources is very quickly checked and protected as a result. An RSVP-supported solution would need two “round trip times” (RTT) compared with only one RTT; in addition, the interworking of RSVP with the hierarchical method explained is not protected. In comparison with the approach according to Chaskar, it is mainly the conditioned performance of a handoff following the availability of resources, which is possible due to the method according to the invention, which must be mentioned as an advantage and the corresponding expansion of the BA message. The procedure according to the invention can be implemented in interworking with any QoS mechanism, particularly with DiffServ, IntServ and MPLS. Furthermore, the mobile node is immediately informed when its quality-of-service requirements cannot be met. According to the invention, this is done by generating a corresponding message in an intermediate entity to be passed along the selected communication path and/or by the corresponding note which is called a negative binding acknowledgment message in the context of the present invention. At the same time, according to the invention, the binding update message is stopped and discarded if not at least the minimum quality-of-service requirements are met. As a result, the mobile node has the possibility of looking for an alternative communication path and there to check again the availability of the existing QoS resources.

Furthermore, the present invention relates to an intermediate entity, particularly a network element, to an IP-based, especially IPv6-based communication path between a mobile node and a correspondent note, where the intermediate entity can be used as intermediate entity in the sense of the method according to the invention. This network element can be, for example, a router, a base station, a controller or a mobility anchor point.

Other advantages of the method according to the invention will be explained with reference to the following figures, in which:

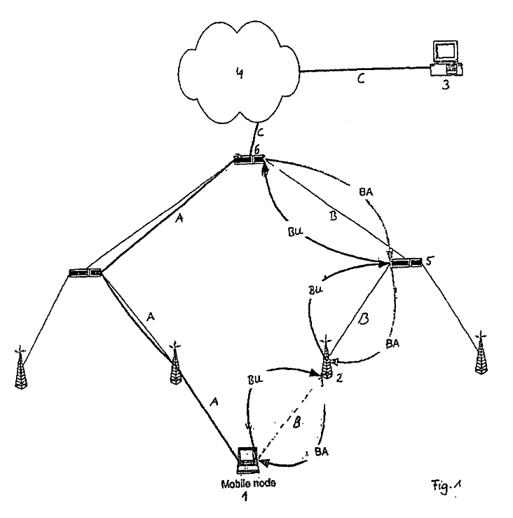

FIG. 1 shows a diagrammatic representation of the progress of an embodiment of the method according to the invention,

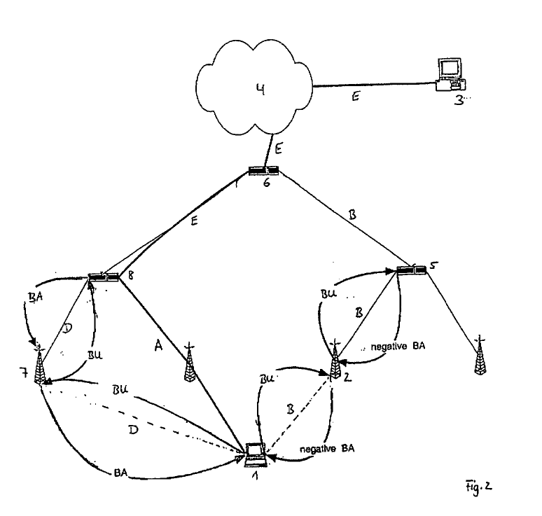

FIG. 2 shows a diagrammatic representation of the progress of a further embodiment of the method according to the invention.

FIG. 1 shows a case in which the mobile node 1 changes its site in the mobile network and, due to this fact, must register with another base station 2. During this process, it also receives a new IP address, to which all information directed to it must be directed, for example, from a correspondent node 3 via the Internet 4. The mobile node 1 must then select a new communication path B which differs from the old communication path A in that it passes other nodes along the way to the correspondent node 3. Although mobile IPv6 guarantees the correct routing of data packets to the mobile node 1 if it has changed its IP address, it does not guarantee adequate quality of service (QoS). To be also able to meet desired quality-of-service requirements or at least minimum quality-of-service requirements, the mobile node 1 then generates a message BU which contains at least the IP address newly allocated to the mobile node 1 and corresponding quality-of-service requirements (QoS). This BU message is then progressively forwarded from the mobile node 1 along the new communication path B from one node to the next node. Those nodes which have nothing to do either with mobility or with protecting quality of service simply forward the BU message. Those nodes in contrast, which are also responsible for protecting quality of service or represent the MAPs are called intermediate entities within the context of the present invention. As a rule and preferably, an MAP will also be responsible for the quality of service but this is not necessarily so. Generally but also not necessarily this firstly includes the corresponding base stations. Accordingly, the mobile node 1 first sends the BU message to its associated base station 2. In the base station 2, a check is then made whether the desired quality-of-service requirements or at least the minimum quality-of-service requirements can be met. The BU message is only forwarded to the next intermediate entity, for example a mobility anchor point 5 if this is the case. In the mobility anchor point 5, as the further intermediate entity along the communication path B, the capability of meeting the quality-of-service requirements is again checked. The sequence is exactly the same as already described in base station 2. The last intermediate entity 6 along the communication path B represents the node at which the old communication path A and new communication path B converge. The quality of service is no longer checked on the matching part C of the communication paths A and B, and this part C is thus completely transparent. The capability of meeting the quality-of-service requirements is already protected by the providing of the old communication path A which has already taken place. This hierarchical procedure is very efficient and considerable time can be saved. In the last intermediate entity 6, a further mobility anchor point in this case, the capability of meeting the quality-of-service requirements is again checked and correspondingly protected. As shown here, this intermediate entity 6 sends a final message BA to the mobile node 1 with the information about which quality-of-service requirements can be met or that at least the minimum quality-of-service requirements can be met. This is accompanied by the actual handoff from the old communication path A to the new communication path B, i.e. the handoff is linked with the condition that an availability of adequate quality-of-service resources on the new communication path B is given. The MAP 6 changes the local route entry or, respectively, the entry of the local communication path and immediately starts to use the new IP address of the MN 1 instead of the old one.

FIG. 2 shows a different sequence of the method according to the invention. Here, too, the mobile node 1 has received a new IP address and attempts to set up a QoS-protected communication path for this address as an alternative to the old communication path A. For this purpose, it again initially sends a BU message to a base station 2 which can be considered by it. This base station checks the quality-of-service requirements, protects the corresponding resources and forwards the BU message to the next intermediate entity which is a mobility anchor point (MAP) 5 in this case. This then determines, during the check of the quality-of-service requirements, that it is unable to provide the corresponding resources. It then sends a negative BA back to the mobile node 1 via the base station 2. There is no handoff from communication path A to the new communication path B. Instead, mobile node 1 tries an alternative new communication path D. It again sends to the corresponding base station 7 a BU message with the corresponding quality-of-service requirements. This BU message is again forwarded, after completed check and protection of the corresponding resources, until either an intermediate entity is reached which cannot meet the corresponding quality-of-service requirements or until an intermediate entity is reached at which the new communication path D intersects the old communication path A. This is shown here in the present case. The two communication paths intersect at mobility anchor point 8. The residual path E up to the correspondent node 3 is identical for both communication paths A and D which guarantees that the corresponding quality-of-service requirements can be met. Thus, no further check with regard to the quality of service is made on this residual path E. As shown here, both the mobility anchor point 8 and the base station 7 can meet the quality-of-service requirements. The mobility anchor point 8 then sends a BA message via the base station 7 to the mobile node 1 with the positive statement that the quality-of-service requirements can be met. Thus a handoff is carried out between the old communication path A and the new communication path D in MAP 8.

1. A method for carrying out a QoS-oriented handoff between a first and a second IP-based, especially mobile IPv6-based communication path between a mobile node (MN) and a correspondent mode (CN) is provided, the second communication path belonging to a number of communication paths accessible to the mobile node, with no, one or a number of intermediate entities and the method exhibiting at least the following steps:
a. selecting a communication path from the number of communication paths accessible to the mobile node as second communication path,
b. generating a message (BU) by the mobile node, which contains at least one IP address allocated to the mobile node on the basis of the selected communication path, and minimum quality-of-service requirements (QoS) with respect to the selected communication path,
c. checking and possibly securing the capability of meeting at least the minimum quality-of-service requirements by the individual intermediate entities successively to be passed by the message on the selected communication path and/or by the correspondent node,
characterized in that
the message contains minimum quality-of-service requirements on a communication from mobile node to correspondent node and/or conversely, and in that a handoff is automatically carried out between the first communication path and the communication path selected as the second one if at least the minimum quality-of-service requirements are met or in that the message is stopped and a message is generated in an intermediate entity and/or in the correspondent node and sent to the mobile node if the capability of meeting at least the minimum quality-of-service requirements is not given.

2. The method as claimed in claim 1, characterized in that the message generated in step b. contains a range of quality-of-service requirements which extends from the minimum quality-of-service requirements up to the desired quality-of-service requirements.

3. The method as claimed in claim 1, characterized in that when a handoff is carried out, a message which provides information about what quality-of-service requirements can be met is generated in an intermediate entity and/or the correspondent node and is sent to the mobile node at the same time or after the handoff has been carried out.

4. The method as claimed in claim 1, characterized in that the intermediate entities are network elements, especially routers, base stations, controllers or mobility anchor points (MAP).

5. The method as claimed in claim 1 characterized in that by combination with hierarchical mobile IP, a nearest suitable intermediate entity stops the message generated in step b. as quickly as possible, generates a message and sends it to the mobile node if the capability of meeting at least the minimum quality-of-service requirements is not given or carries out the handoff if at least the minimum quality-of-service requirements are met.

6. Intermediate entity, particularly a network element, on an IP-based, especially an IPv6-based, communication path between a mobile node and a corresponding node, characterized in that the intermediate entity can be used as intermediate entity in the sense of the method as claimed in claim 1.
